(19) United States
(12) Patent Application Publication
(10) Pub. No.: US 2005/0124757 A1
(43) Pub. Date: Jun. 9, 2005

(54) Primary aqueous dispersion hardened by actinic radiation, method for production and use thereof

(76) Inventors: Heinz-Peter Rink, Munster (DE); Wilma Locken, Haltern (DE); Ulrike Licht, Mannheim (DE); Susanne Neumann, Munster (DE)

Correspondence Address: BASF CORPORATION;ANNE GERRY SABOURIN, 26701 TELEGRAPH ROAD, SOUTHFIELD, MI, 48034-2442, US

(21) Appl. No.: 10/505,538

(22) PCT Filed: Mar. 19, 2003
(86) PCT No.: PCT/EP03/02853

(30) Foreign Application Priority Data
Mar. 28, 2002 (DE) 102139709

(51) Int. Cl. C08K 3/00

(52) U.S. Cl. 524/589

(57) ABSTRACT

An aqueous primary dispersion curable with actinic radiation and comprising liquid and/or solid, emulsified and/or dispersed polymer particles with a z-average diameter ≦500 nm, preparable by polyaddition in a microemulsion and/or miniemulsion of at least (A) at least one polyisocyanate, (B) at least one polyol and (C) at least one compound containing at least one isocyanate-reactive functional group and at least one reactive functional group containing at least one bond which can be activated with actinic radiation; process for preparing it, and its use.

The present invention relates to novel aqueous primary dispersions curable with actinic radiation. The present invention also relates to a novel process for preparing aqueous primary dispersions curable with actinic radiation. The present invention further relates to the use of the novel aqueous primary dispersions curable with actinic radiation as coating materials, adhesives, and sealing compounds or for producing coating materials, adhesives, sealing compounds, films, and moldings.

Aqueous secondary dispersions curable with actinic radiation are known. They are prepared conventionally by polyaddition of diisocyanates and, if desired, polyisocyanates, compounds containing at least two isocyanate-reactive groups, and compounds containing at least one isocyanate-reactive group and at least one reactive functional group having at least one bond which can be activated with actinic radiation, in organic solvents. The resultant organic solution of the polyurethanes curable with actinic radiation is dispersed in an aqueous medium to give the secondary dispersion (cf., for example, patent applications EP 0 401 565 A1, EP 0 522 420 A1, EP 0 522 419 A2, EP 0 755 946 A1, EP 0 608 021 A1, EP 0 708 788 A1, EP 0 730 613 A1, DE 199 14 896 A1, DE 199 53 446 A1 or DE 199 53 203 A1).

A disadvantage here is that the secondary dispersions contain comparatively large amounts of organic solvents which must be removed by distillation or azeotropic distillation if the secondary dispersions are to be substantially or entirely free from organic solvents. This removal, however, constitutes a considerable additional processing effort. Moreover, the polyurethanes curable with actinic radiation must contain cationic or anionic and/or nonionic hydrophilic groups in order to have self-dispersing properties. Such groups may, however, reduce the water resistance of polyurethane films.

It is an object of the present invention to provide a novel aqueous primary dispersion curable with actinic radiation that no longer has the disadvantages of the prior art but instead is easy to prepare and is substantially or entirely free from organic solvents, and is stable on storage. The novel aqueous primary dispersion curable with actinic radiation ought to be useful as a coating material, adhesive, and sealing compound. Moreover, it ought to be very highly suitable for preparing coating materials, adhesives, and sealing compounds curable with actinic radiation or both thermally and with actinic radiation. It ought not least to be very highly suitable as well for producing films and moldings.

The invention accordingly provides the novel aqueous primary dispersion curable with actinic radiation and comprising liquid and/or solid, emulsified and/or dispersed polymer particles with a z-average diameter ≦500 nm, preparable by polyaddition in a microemulsion and/or miniemulsion of at least
(A) at least one polyisocyanate,
(B) at least one polyol and
(C) at least one compound containing at least one isocyanate-reactive functional group and at least one reactive functional group containing at least one bond which can be activated with actinic radiation.

The novel aqueous primary dispersion curable with actinic radiation is referred to below as “primary dispersion of the invention”.

The invention further provides the novel process for preparing aqueous primary dispersions curable with actinic radiation and comprising liquid and/or solid, emulsified and/or dispersed polymer particles with a z-average diameter ≦500 nm, which involves
(1) preparing a microemulsion or miniemulsion from at least
   (A) at least one polyisocyanate,
   (B) at least one polyol and
   (C) at least one compound containing at least one isocyanate-reactive functional group and at least one reactive functional group containing at least one bond which can be activated with actinic radiation and
(2) carrying out polymerization by polyaddition.

The novel process for preparing aqueous primary dispersions curable with actinic radiation is referred to below as “process of the invention”.

In the light of the prior art it was surprising and unforeseeable for the skilled worker that the object on which the present invention was based could be achieved by means of the primary dispersion of the invention and by means of the process of the invention. In particular it was surprising that the process of the invention gave primary dispersions which were extensively or entirely free from organic solvents. A further surprise was that the primary dispersion of the invention could be made very fine and was completely stable on storage despite the fact that the primary particles contained only a small number, if any, of ionic or nonionic hydrophilic groups. Surprising not least was the fact that the primary dispersion of the invention was capable of extraordinarily broad application. For instance, it could be used directly as a coating material, adhesive, and sealing compound. It was also outstandingly suitable for preparing coating materials, adhesives, and sealing compounds curable with actinic radiation or both thermally and with actinic radiation, and for producing films and moldings. The coatings, adhesive films and seals produced from the coating materials, adhesives, and sealing compounds of the invention, and also the films and moldings, had outstanding performance properties. In particular, they had a very high water resistance.

Here and below, actinic radiation means electromagnetic radiation, such as visible light, UV radiation, and X-rays, especially UV radiation, and corpuscular radiation, such as electron beams.

The curing of coating materials, adhesives, and sealing compounds using heat and actinic radiation is also referred to by those in the art as dual cure.

Microemulsions and miniemulsions are dispersions or emulsions comprising water, an oil phase, and one or more surface-active substances and having a droplet size of from 5 to 50 nm (microemulsions) or from 50 to 500 nm (miniemulsions). Microemulsions are considered thermodynamically stable, whereas the miniemulsions are regarded as being metastable (cf. Emulsion Polymerization and Emulsion Polymers, edited by P. A. Lovell and Mohamed S. El-Aasser, John Wiley and Sons, Chichester, N.Y., Weinheim, 1997, pages 700 et seq; Mohammed S. El-Aasser, Advances in Emulsion Polymerization and Latex Technology, 30th Annual Short Course, volume 3, Jun. 7-11, 1999, Emulsion Polymers Institute, Lehigh University, Bethlehem, Pa., USA).

The primary dispersion of the invention has a z-average particle size of ≦500 nm, preferably ≦400 nm. This size may be determined, for example, conventionally by means of photon correlation spectroscopy in accordance with the principle of dynamic, quasi-elastic light scattering. This can be done using, for example, a Coulter N4 Plus Particle Analyzer from Coulter Scientific Instruments or a PCS Malvern Zetasizer 1000. The measurement is normally conducted on an aqueous emulsion containing 0.01% by weight of the emulsified polymer particles. The primary dispersion of the invention preferably has a z-average particle size of ≧50 nm. The size in particular is between 100 and 350 nm.

The primary dispersion of the invention may have a monomodal or multimodal, especially bimodal, particle size distribution. In the case of a bimodal particle size distribution it is possible for from 0.1 to 80% by weight, in particular from 1.0 to 50% by weight, of the polymer particles to have a size, determined with an analytical ultracentrifuge, of from 20 to 500 nm, in particular from 50 to 300 nm. From 20 to 99.9% by weight, in particular from 50 to 99% by weight, of the polymer particles may have a size of from 200 to 1500 nm, in particular from 300 to 900 nm, with the particle sizes differing by at least 50 nm, in particular by at least 100 nm, with very particular preference by at least 200 nm. As regards the measuring method, refer for further details to lines 5 to 9 of page 6 of German patent application DE 196 28 142 A1.

The solids content of the primary dispersion of the invention may vary very widely and is guided by the dispersibility of the polymer particles and the requirements of the particular end use. The solids content is preferably from 20 to 70% by weight, more preferably from 25 to 65% by weight, with particular preference from 30 to 60% by weight, and in particular from 35 to 55% by weight.

The dispersion of the invention is preparable by polyaddition of at least
(A) at least one, especially one, polyisocyanate,
(B) at least one, especially one, polyol and
(C) at least one, especially one, compound containing at least one, especially one, isocyanate-reactive functional group and at least one, especially one, reactive functional group containing at least one, especially one, bond which can be activated with actinic radiation
   in a miniemulsion or microemulsion, preferably in a miniemulsion.

The miniemulsion comprising the starting compounds (A), (B) and (C) is preparable by homogenizing the mixture of the starting products and emulsifying the mixture in an aqueous medium in a high shear field. Examples of suitable apparatus and techniques are described in patents DE 196 28 142 A1, page 5 lines 1 to 30, DE 196 28 143 A1, page 7 lines 30 to 58, or EP 0 401 565 A1, lines 27 to 51. The mixing, homogenizing, and emulsifying of the starting products are preferably conducted in the absence of actinic radiation.

The aqueous medium or aqueous phase may comprise additives, such as customary and known dispersing auxiliaries or emulsifiers, protective colloids and/or defoamers.

The polyaddition or the process of the invention is preferably conducted in the presence of emulsifiers and/or protective colloids. Examples of suitable emulsifiers and/or protective colloids and of the amounts in which they are advantageously employed are disclosed in German patent application DE 196 28 142 A1, page 3 lines 8 to 48.

It is also possible for hydrophobic compounds to be present as well. These hydrophobic compounds are also referred to by those in the art as costabilizers.

The hydrophobic compounds comprise water-insoluble substances which are oligomeric, polymeric or of low molecular mass.

Examples of suitable hydrophobic compounds are customary and known crosslinking agents, such as amino resins; blocked polyisocyanates, or tris(alkoxycarbonylamino)triazines, esters of alpha,beta-monoolefinically unsaturated carboxylic acids having from 3 to 6 carbon atoms with alcohols having from 12 to 30 carbon atoms in the alkyl radical; esters of vinyl alcohol and/or allyl alcohol with alkane monocarboxylic, alkane monosulfonic and/or alkane monophosphonic acids having from 12 to 30 carbon atoms in the molecule; amides of alpha,beta-monoolefinically unsaturated carboxylic acids having from 3 to 6 carbon atoms with alkylamines having from 12 to 30 carbon atoms in the alkyl radical; macromonomers based on olefinically unsaturated compounds containing on average per molecule at least one, especially terminal, olefinically unsaturated group; polysiloxane macromonomers containing on average per molecule at least one, especially terminal, olefinically unsaturated group; oligomeric and/or polymeric products of addition polymerization, polycondensation and/or polyaddition; water-insoluble molecular weight regulators, especially mercaptans; aliphatic, cycloaliphatic and/or aromatic halogenated and/or nonhalogenated hydrocarbons; alkanols and/or alkylamines having at least 12 carbon atoms in the alkyl radical; organosilanes and/or organosiloxanes; vegetable, animal, semisynthetic and/or synthetic oils; hydrophobic dyes. Further examples of suitable hydrophobic compounds or costabilizers and of the amounts in which they are advantageously employed are known from German patent application DE 196 28 142 A1, page 4 lines 37 to 59.

The mixture of the essential starting compounds preferably further comprises customary and known additives, especially light stabilizers, such as UV absorbers and reversible free-radical scavengers (HALS), and polyaddition catalysts, such as organic dialkyltin compounds, especially dibutyltin dilaurate, in customary and known, effective amounts.

The polyaddition is preferably conducted at a temperature from 30 to 150° C., more preferably from 40 to 120° C., and in particular from 50 to 100° C. At reaction temperatures >100° C., pressure-rated reactors are employed. Examples of suitable reactors are stirred tanks, tube reactors, loop reactors or Taylor reactors, especially stirred tanks.

As starting compounds (A), (B) and (C) it is possible to use all compounds such as are commonly used for preparing polyurethanes. It is an extraordinary advantage of the primary dispersion of the invention and of the process of the invention that such a large number of readily available compounds may be employed.

Accordingly, the polyisocyanates (A) are preferably selected from the group consisting of customary and known aliphatic, cycloaliphatic, aromatic, aliphatic-cycloaliphatic, aliphatic-aromatic, cycloaliphatic-aromatic, aliphatic-cycloaliphatic-aromatic polyisocyanates, preferably aliphatic, cycloaliphatic, and aliphatic-cycloaliphatic polyisocyanates. The polyisocyanates (A) in particular comprise diisocyanates. Examples of suitable polyisocyanates (A) are known from German patent application DE 199 14 896 A1, column 4 line 42 to column 5 line 33.

The polyols (B) are preferably selected from the group consisting of low molecular mass polyols (B 1) and also oligomeric and polymeric polyols (B2), especially oligomeric and polymeric polyols (B2). The polyols preferably comprise diols. The low molecular mass polyols (B1) preferably have a number-average molecular weight <200 daltons and the oligomeric and polymeric polyols (B2) preferably have a number-average molecular weight >200 daltons. The molar ratio (B1):(B2) is preferably >1:10.

Examples of suitable polyols (B) are known from German patent application DE 199 14 896 A1, column 5 line 35 to column 8 line 35 and column 15 lines 13 to 46. Very particular preference is given to the polyester polyols (B2), especially the aliphatic, cycloaliphatic and aliphatic-cycloaliphatic polyester polyols (B2).

The compounds (C) are also customary and known. The bonds which can be activated with actinic radiation that are present in the reactive functional groups of the compounds (C) are preferably selected from the group consisting of carbon-hydrogen single bonds or carbon-carbon, carbon-oxygen, carbon-nitrogen, carbon-phosphorus or carbon-silicon single bonds or double bonds. In particular the double bonds are carbon-carbon double bonds (“double bonds”).

The double bonds are preferably present in reactive functional groups selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups. In particular, the reactive functional groups are acrylate groups.

The isocyanate-reactive functional groups present in the compounds (C) are preferably selected from the group consisting of hydroxyl groups, thiol groups, and primary and secondary amino groups. In particular the isocyanate-reactive functional groups are hydroxyl groups.

The compounds (C) are preferably selected from the group consisting of hydroxyalkyl and hydroxycycloalkyl acrylates. Examples of suitable compounds (C) of this kind are 2-hydroxyethyl, 2- and 3-hydroxypropyl, and 4-hydroxybutyl acrylate and cyclohexanedimethanol monoacrylate.

Besides the essential starting products described above, it is also possible to use compounds (D) which are different than the compounds (B) and (C) and contain at least one, preferably at least two, and in particular two, of the above-described isocyanate-reactive functional groups. The compounds (D) may contain no or at least one customary and known reactive functional group which is able to enter into crosslinking reactions “with itself” and/or else also with complementary reactive functional groups other than isocyanate groups. Examples of suitable groups of this kind are carboxyl groups, epoxide groups or alkoxymethylene groups. In addition to these groups or instead of them, the compounds (D) may contain at least one hydrophilic functional group selected from the group consisting of (potentially) anionic groups, such as carboxyl or sulphonic acid groups, or (potentially) cationic groups, such as amino groups, and nonionic hydrophilic functional groups, such as polyalkylene oxide groups, especially polyethylene oxide groups.

Examples of suitable compounds (D) are known from German patent application DE 199 14 896 A1, column 9 lines 36 to 67.

In the process of the invention the compounds (D) are preferably added during the polyaddition of the aqueous phase. Where polyamines, for example, especially diamines, are added as (D), the polyurethanes present in the polymer particles may be chain-extended in this way.

The equivalents ratio of free isocyanate groups in the polyisocyanates (A) to the sum of the isocyanate-reactive groups in the starting compounds (B) and (C) and also, where used, (D) is preferably chosen so that there are no longer any free isocyanate groups in the polymer particles. The equivalents ratio is therefore preferably <1, in particular <0.9. However, the chosen equivalents ratio should not be so small that after the end of the polyaddition there are still free starting compounds (B) and (C) and also, where used, (D).

In a further embodiment in accordance with the invention, the polymer particles of the primary dispersion of the invention are exposed to actinic radiation, especially UV radiation, prior to, during and/or after, particularly after, the polyaddition. This raises the number-average and mass-average molecular weight of the polyurethanes in the polymer particles. Irradiation may also be carried out until the polymer particles have been partially or fully crosslinked and are in the form of crosslinked microparticles. The crosslinked microparticles are also curable with actinic radiation if they still contain a certain number of the above-described reactive functional groups which can be activated with actinic radiation.

The primary dispersion of the invention has numerous special advantages. Thus it is substantially or entirely free from organic solvents. “Substantially free” denotes that the solvent content is <5%, preferably <2%, and in particular <1%, by weight. “Entirely free” denotes that the solvent content is below detection limits of the conventional techniques for analyzing organic solvents.

The primary dispersion of the invention is outstandingly suitable as a coating material, adhesive or sealing compound curable with actinic radiation. It is also outstandingly suitable for preparing coating materials, adhesives, and sealing compounds, especially coating materials, which are curable with actinic radiation or by dual cure. Not least it is outstandingly suitable for producing films and moldings, especially optical moldings.

The coating materials of the invention may be used as clearcoat materials for producing clearcoats, especially in multicoat color and/or effect paint systems. Alternatively, they may be used as surfacers or solid-color and/or effect topcoats or color and/or effect basecoats. For this purpose they may be admixed with customary and known color pigments, optical effect pigments, electrically conductive pigments, magnetically shielding pigments, fluorescent pigments, anticorrosion pigments and/or extender pigments. To prepare dual-cure coating materials of the invention the primary dispersion of the invention may also be admixed with thermally curable primary dispersions based on miniemulsions, such as are known from patent applications DE 199 59 927 A1, DE 199 59 928 A1, DE 199 59 923 A1 or DE 100 05 819 A1.

The preparation of the coating materials of the invention has no special features in terms of method but can instead be carried out using the customary and known apparatus and techniques. Examples of suitable techniques are spraying, knife coating, brushing, flow coating, dipping, trickling or rolling. It is preferred to employ spray application techniques.

The applied coating materials, after flashing off and drying where appropriate, are cured conventionally with actinic radiation or both thermally and with actinic radiation, especially UV radiation.

Preferably, the pigmented coating materials are cured thermally and with actinic radiation and the unpigmented coating materials are cured with actinic radiation.

For the thermal cure it is possible to use conventional apparatus, such as forced-air ovens or radiant heaters.

For the actinic radiation cure it is possible to use conventional light sources, such as UV lamps. In the case of curing with actinic radiation it is preferred to use a radiation dose of from 10³ to 4×10⁴ preferably from 2×10³ to 3×10⁴, more preferably from 3×10³ to 2.5×10⁴, and in particular from 5×10³ to 2×10⁴ J m⁻². The radiative intensity in this case is from 1×10⁰ to 3×10⁵, preferably from 2×10⁰ to 2×10⁵, more preferably from 3×10⁰ to 1.5×10⁵, and in particular from 5×10⁰ to 1.2×10⁵, W m⁻².

Curing with actinic radiation is preferably conducted in an oxygen-depleted atmosphere.

The resultant coatings of the invention have outstanding performance properties. They are smooth and free from surface defects, of high gloss, bright, hard, flexible, mar resistant, chemical resistant, water resistant, and stable to weathering. They adhere firmly to coated and uncoated substrates of wood, metal, glass, leather, plastics, ceramics, natural stone, artificial stone or paper, and composites of these materials.

The adhesive films of the invention have a durably high bond strength even under extreme conditions. The seals of the invention seal substrates of the abovementioned kind durably and even with respect to aggressive substances. The films and moldings of the invention have a profile of properties that corresponds in its entirety to that of the coatings of the invention.

### EXAMPLE

The Preparation of a UV-Curable Aqueous Primary Dispersion

In a stainless steel reactor
12.33 parts by weight of tetramethylxylylidenediisocyanate (TMXDI® from CYTEC),
0.545 part by weight of Irgacure® 184 (commercial photoinitiator),
0.44 part by weight of Tinuvin® 400 (commercial UV absorber from Ciba Specialty Chemicals, 85 percent in methoxy-2-propanol),
0.364 part by weight of Tinuvin® 292 (commercial UV absorber from Ciba Specialty Chemicals),
0.182 part by weight of 4-hydroxy-2,2,6,6-tetramethylpiperidine-1-oxyl (HALS),
18.28 parts by weight of a polyester made from—based on the polyester—41.906% by weight hexahydrophthalic anhydride, 13.951% by weight hexanediol and 44.144% by weight ethylbutylpropanediol; characteristic data: hydroxyl number: 153.7 mg KOH/g; acid number: 10.7 mg KOH/g; number-average molecular weight 682 daltons,
7.27 parts by weight of hydroxybutyl acrylate and
0.018 part by weight of dibutyltin dilaurate
   were weighed out, mixed with one another, and homogenized.

In a separate vessel, 55.207 parts by weight of deionized water, 5.106 parts by weight of the commercial emulsifier Abex® EP 110 from Rhone Poulenc Surfactants & Specialties, and 0.159 part by weight of the commercial defoamer Agitan® 281 were mixed with one another and homogenized.

The aqueous emulsifier/defoamer solution was added with stirring to the organic mixture. The resultant mixture was homogenized using an Ultraturrax at 10 000 rpm for 30 seconds. The resultant suspension was subsequently converted into a miniemulsion (z-average particle size: 200 nm, measured using a PCS Malvern Zetasizer 1000) by dispersing it for 5 minutes using a nozzle jet homogenizer from Wagner at a pressure of 180 bar. The miniemulsion was stirred at 80° C. until the theoretical solids content of 40% by weight was reached.

The miniemulsion or primary dispersion was stable on storage. It was used as it was as a UV-curable coating material and adhesive and also as a UV-curable sealing compound. As a coating material, following application to substrates, it gave hard, mar-resistant, flexible, chemical-resistant and weathering-stable clearcoats. However, it was also used for preparing coating materials, adhesives, and sealing compounds curable thermally and with actinic radiation. For this purpose, the miniemulsion was blended with customary and known dispersions of thermally curable coating materials, adhesives, and sealing compounds. Owing to its advantageous properties, the miniemulsion also lent itself very well to use for producing films, especially dry-paint films, and moldings. Since the miniemulsion was substantially free from organic solvents, there was no need to take special safety measures, such as the suction withdrawal of volatile organic solvents or the shunting of static electricity, during its preparation, application or curing.

1. An aqueous primary dispersion curable with actinic radiation and comprising liquid and/or solid polymer particles that are emulsified and/or dispersed and have a z-average diameter ≦500 nm, wherein the polymer particles are a microemulsion and/or miniemulsion polyaddition product of at least
(A) at least one polyisocyanate,
(B) at least one polyol and
(C) at least one compound containing at least one isocyanate-reactive functional group and at least one reactive functional group containing at least one bond which can be activated with actinic radiation.

2. The dispersion of claim 1, wherein the particles have a z-average particle diameter from 50 to 500 nm.

3. The dispersion of claim 1, wherein particles have a z-average particle diameter ≦400 nm.

4. The dispersion of claim 1, wherein the particles have a z-average particle diameter of from 100 to 350 nm.

5. The dispersion of claim 1, wherein the at least one polyisocyanates (A) is a diisocyanates.

6. The dispersion of claim 1, wherein the at least one polyisocyanates (A) is selected from the group consisting of aliphatic polyisocyanates, cycloaliphatic polyisocyanates, aromatic polyisocyanates, aliphatic-cycloaliphatic polyisocyanates, aliphatic-aromatic polyisocyanates, cycloaliphatic-aromatic polyisocyanates, aliphatic-cycloaliphatic-aromatic polyisocyanates, and combinations thereof.

7. The dispersion of claim 1, wherein the at least one polyols (B) is selected from the group consisting of polyols (B1) having a number-average molecular weight <200 daltons, and also oligomeric and polymeric polyols (B2).

8. The dispersion of claim 7, wherein the oligomeric and polymeric polyols (B2) have a number-average molecular weight >200 daltons.

9. The dispersion of claim 7, wherein a molar ratio (B1):(B2) is >1:10.

10. The dispersion of claim 7, wherein the polyols (B2) are polyester polyols.

11. The dispersion of claim 1, wherein the bonds which can be activated with actinic radiation that are present in the reactive functional groups of the at least one compounds (C) are selected from the group consisting of carbon-hydrogen single bonds, carbon-carbon single bonds, carbon-oxygen single bonds, carbon-nitrogen single bonds, carbon-phosphorus single bonds, carbon-silicon single bondsmen carbon-carbon double bonds, carbon-oxygen double bonds, carbon-nitrogen double bonds, carbon-phosphorus double bonds, or carbon-silicon double bonds.

12. The dispersion of claim 11, wherein the double bonds are carbon-carbon double bonds.

13. The dispersion of claim 12, wherein the double bonds are present in reactive functional groups selected from the group consisting of (meth)acrylate groups, ethacrylate groups, crotonate groups, cinnamate groups, vinyl ether groups, vinyl ester groups, dicyclopentadienyl groups, norbornenyl groups, isoprenyl groups, isopropenyl groups, allyl groups butenyl groups, dicyclopentadienyl ether groups, norbornenyl ether groups, isoprenyl ether groups, isopropenyl ether groups, allyl ether groups butenyl ether groups, dicyclopentadienyl ester groups, norbornenyl ester groups, isoprenyl ester groups, isopropenyl ester groups, allyl ester groups or butenyl ester groups.

14. The dispersion of claim 13, wherein the reactive functional groups are acrylate groups.

15. The dispersion of claim 1, wherein the at least one isocyanate-reactive functional groups present in the at least one compounds (C) is selected from the group consisting of hydroxyl groups, thiol groups, primary amino groups, secondary amino groups, and combinations thereof.

16. The dispersion of claim 15, wherein the at least one isocyanate-reactive functional groups is a hydroxyl groups.

17. The dispersion of claims 14, wherein the at least one compounds (C) is selected from the group consisting of hydroxyalkyl acrylates and hydroxycycloalkyl acrylates.

18. The dispersion of claim 1, wherein the polymer particles polyaddition products of A B C and (D) at least one compound different than (B) and (C) and containing at least one isocyanate-reactive functional group.

19. The dispersion of claim 18, wherein the at least one isocyanate-reactive functional groups present in the at least one compounds (D) is selected from the group consisting of hydroxyl groups, thiol groups, primary amino groups, secondary amino groups, and combinations thereof.

20. The dispersion of claim 18, wherein the at least one compounds (D) further contains at least one functional group selected from the group consisting of reactive functional groups which are able to enter into reactions with themselves and/or with complementary reactive functional groups, and hydrophilic functional groups.

21. The dispersion of claim 20, wherein the hydrophilic functional groups are selected from the group consisting of (potentially) anionic groups, (potentially) cationic groups, and nonionic hydrophilic functional groups.

22. The dispersion of claim 18, wherein the at least one compound (D) is added to the aqueous phase of the microemulsion or miniemulsion during the polyaddition.

23. The dispersion of one of claims 1 to 22, wherein the polymer particles are exposed to actinic radiation prior to, during and/or after the polyaddition.

24. The primary dispersion of claim 1, wherein the dispersion has a solids content of from 5 to 70% by weight.

25. A process for preparing the aqueous primary dispersions curable with actinic radiation, of claims 1 comprising
(1) preparing a microemulsion or miniemulsion from at least
(A) at least one polyisocyanate,
(B) at least one polyol and
(C) at least one compound containing at least one isocyanate-reactive functional group and at least one reactive functional group containing at least one bond which can be activated with actinic radiation and
(2) carrying out polymerization by polyaddition.

26. The process of claim 25, wherein the microemulsion or miniemulsion further comprises
(D) at least one compound different than (B) and (C) and containing at least one isocyanate-reactive functional group.

27. The process of claim 26, wherein the compound (D) is added to the aqueous phase during the polyaddition.

28. The process of claim 25, wherein the miniemulsion or microemulsion is exposed to actinic radiation prior to, during, and/or after the polyaddition.

29. The process of claim 25, wherein the polyaddition is conducted at a temperature of from 30 to 150° C.

30. The dispersions of claim 1, wherein the dispersion is one of a coating materials, an adhesives, and a sealing compounds.
